(19) United States
(12) Patent Application Publication
(10) Pub. No.: US 2006/0290285 A1
(43) Pub. Date: Dec. 28, 2006

(54) Rapid Warm-up Ceramic Metal Halide Lamp

(75) Inventors: Walter P. Lapatovich, Boxford, MA (US); George C. Wei, Weston, MA (US); Joanne M. Browne, Newburyport, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/160,454

(22) Filed: Jun. 24, 2005

(51) Int. Cl. H01J 17/16

(52) U.S. Cl. 313/636

(57) ABSTRACT

A ceramic metal halide lamp is provided wherein the ceramic discharge vessel is comprised of dysprosium oxide. The lamp has a warm-up time that is less than about 50%, and preferably less than about one-third, of the warm-up time of a similarly constructed and operated lamp having a ceramic discharge vessel made of polycrystalline aluminum oxide.

### BACKGROUND OF THE INVENTION

Metal halide discharge lamps have been favored for their high efficacies and high color rendering properties which result from the complex emission spectra generated by their rare-earth chemistries. Particularly desirable are ceramic metal halide lamps which offer improved color rendering, color temperature, and efficacy over traditional quartz arc tube types. This is because ceramic materials can operate at higher temperatures than quartz and are less prone to react with the various metal halide chemistries. The preferred ceramic material is polycrystalline aluminum oxide (polycrystalline alumina or PCA).

Various shapes have been proposed for ceramic discharge vessels ranging from a right circular cylindrical shape to an approximately spherical (bulgy) shape. Examples of these types of arc discharge vessels are given in European Patent Application No. 0 587 238 A1 and U.S. Pat. No. 5,936,351, respectively. The bulgy shape with its hemispherical ends is preferred because it yields a more uniform temperature distribution, resulting in reduced corrosion of the discharge vessel by the metal halide fill materials.

One limitation to introducing ceramic metal halide lamps into broader markets (such as residential applications) is the time that it takes for the lamp to warm-up and reach its steady-state operating condition with full light output or steady-state operating voltage. For a typical ceramic metal halide lamp, this warm-up period may take several tens to hundreds of seconds, depending on the amount of power delivered and the heat capacity of the lamp. Larger lamps have greater mass and heat capacity and thus require a longer time to absorb enough energy to raise their temperature to the point where the metal halide salts are sufficiently vaporized to produce the desired light output. Besides limiting the applications for ceramic metal halide lamps, slow warming can also result in sputtering of the tungsten electrodes leading to blackening of the lamp and a decrease in light output.

One method that has been used to decrease the warm-up period is to overpower the lamp for an initial period until the lamp is fully operational. For example, automotive lamps which normally operate at 35 W are routinely ignited and operated at about 90 W for several seconds because of the need for instant lighting of the roadway. However, this approach requires a different ballast to operate the lamp and is practical only when new fixtures are installed. In addition, the over-wattage condition risks cracking and explosive failure of the ceramic discharge vessel from the thermal shock.

U.S. Pat. No. 6,294,871 describes doping ceramic bodies, primarily polycrystalline alumina arc tubes, with a UV-absorbing additive selected from europium oxide, titanium oxide and cerium oxide to provide UV attenuation. The doping is preferably done at a level below about 5000 ppm in order to preserve translucency. Other oxides of rare earth metals including lanthanum, dysprosium and neodymium are also cited as possibly providing UV attenuation. Another effect attributed to the dopants is allowing the arc tube to run at a higher temperature. However, the patent contains no information on the effect on the warm-up time of the arc tubes.

Thus, it would be advantageous to provide a rapid warm-up ceramic metal halide lamp that could be used in existing fixtures or other applications where rapid warm-up is desired.

### SUMMARY OF THE INVENTION

We have discovered that the warm-up time of ceramic metal halide lamps may be dramatically shortened, by at least about 50%, by making the discharge vessel out of polycrystalline dysprosium oxide (dysprosia), Dy₂O₃. The reason for the shorter warm-up time is believed to be a result of the strong absorption bands of polycrystalline dysprosia in the range of 275-475 nm in combination with a heat capacity that is lower than PCA. These strong absorption bands, which are not present in undoped PCA, absorb UV and blue radiation emitted by the discharge which is then converted to heat causing to a quicker warming of the discharge vessel and the components of the metal halide fill. The lower heat capacity means that less heat is needed to increase the vessel temperature.

In a conventional metal halide lamp containing mercury, the emitted radiation from the discharge during the warm-up phase is typically Hg atomic emission with strong lines at 254 nm, 365 nm, and 436 nm. In effect, the low power phase during warm-up produces blue and UV radiation which previously exited the PCA discharge vessel. The instant invention captures this radiation and converts it into heat in the ceramic body of the discharge vessel. Essentially, the amount of power available for heating the discharge vessel is increased during the warm-up phase with no overt electrical overpowering of the ballast.

A metal halide lamp made with a polycrystalline dysprosium oxide discharge vessel has a warm-up time that is less than about 50%, and preferably less than about one-third, of the warm-up time of a similarly constructed and operated lamp made with a PCA discharge vessel. For example, a 70 W ceramic metal halide lamp can have a warm-up time of less than about 20 seconds with a Dy₂O₃ discharge vessel compared to greater than 50 seconds for the same lamp with a Al₂O₃ discharge vessel when operated under normal, i.e., not over-wattage, conditions. Since the rapid warm-up is achieved only by a change in the ceramic material, the metal halide lamps according to this invention can be operated in existing fixtures without the need for changing the electrical ballast. As used herein, the term “ceramic metal halide lamp” also includes lamps with a ceramic discharge vessel that contains substantially only metallic mercury as a fill.

### BRIEF DESCRIPTION OF THE DRAWINGS

FIG. 1 is a cross-sectional illustration of a ceramic metal halide discharge vessel according to this invention.

FIG. 2 is an illustration of a ceramic metal halide lamp.

FIG. 3 is a graphical illustration of the electrical characteristics of an operating ceramic metal halide lamp according to this invention.

FIG. 4 is a graphical illustration of the variation of Vᵢₘₐₓ with time for a ceramic metal halide lamp according to this invention vs. a similarly constructed and operated metal halide lamp having a conventional PCA discharge vessel.

FIG. 5 is a graph of the in-line transmittance of a polished polycrystalline dysprosium oxide disk.

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

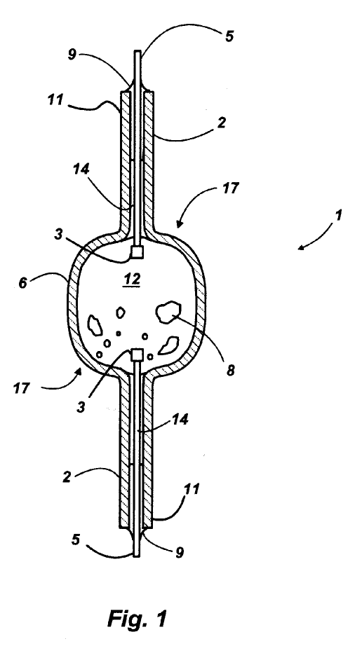

Referring now to FIG. 1, there is shown a cross-sectional illustration of a discharge vessel for a metal halide lamp according to his invention. The discharge vessel 1 is bulgy-shaped with hemispherical end wells 17. The bulgy-shaped vessel has a hollow, axially symmetric body 6 which encloses a discharge chamber 12. The body of the discharge vessel is comprised of polycrystalline dysprosium oxide.

Two opposed capillary tubes 2 extend outwardly from the body 6 along a central axis. The capillary tubes in this embodiment have been integrally molded with the ceramic body. The discharge chamber 12 may contain a buffer gas, e.g., 30 torr to 20 bar Ar, Ne, Kr, Xe or mixtures thereof, and a metal halide fill 8, e.g., mercury plus a mixture of metal halide salts, e.g., NaI, CaI₂, DyI₃, HoI₃, TmI₃, and TlI. Lamp fills are not limited to these specific salts. Other rare earth, alkali, and alkaline metal salts may also be used, such as PrI₃, LiI, or BaI₂. The metal halide fill may also be mercury-free in which case the metal halide salt mixture may also contain other easily volatilized components such as InI and ZnI₂. The fill 8 may also be substantially only mercury in sufficient quantity to produce approximately a 200 bar operating pressure.

Electrodes assemblies 14 are sealed to capillaries 2 with a frit material 9. The discharge tips 3 of the electrode assemblies 14 protrude into the discharge chamber 12 and the opposite ends 5 extend beyond the distal ends 11 of the capillaries in order to supply electrical power to the discharge vessel. Electrical power may be supplied by a number of ballast types (not shown) including lead or lag, 50 or 60 Hz conventional magnetic ballasts, or an electronic ballast at a suitable frequency to operate the lamp in frequency regions clear of undesirable acoustic resonances, e.g., a 90 Hz square wave.

In a preferred structure, the electrode assemblies are constructed of a niobium feedthrough, a tungsten electrode, and a molybdenum coil that is wound around a molybdenum or Mo—Al₂O₃ cermet rod that is welded between the tungsten electrode and niobium feedthrough. A tungsten coil or other suitable means of forming a point of attachment for the arc may be affixed to the tip 3 of the tungsten electrode. The frit material 9 creates a hermetic seal between the electrode assembly 14 and capillary 2. In metal halide lamps, it is usually desirable to minimize the penetration of the frit material into the capillary to prevent an adverse reaction with the corrosive metal halide fill.

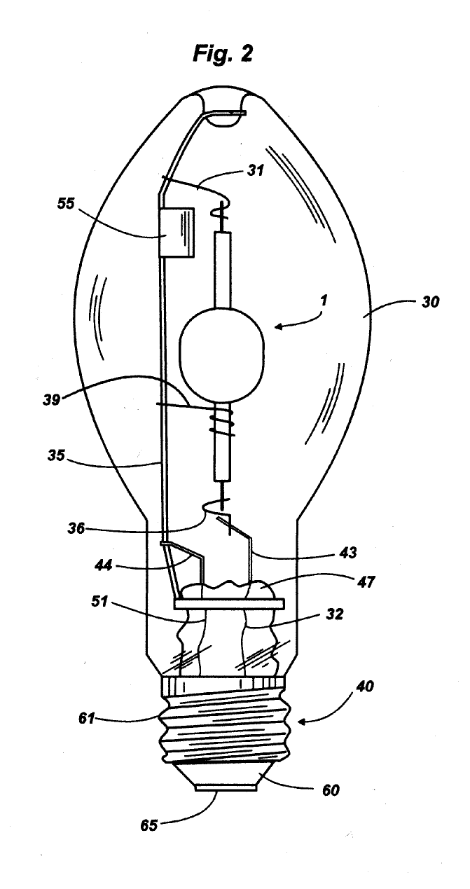

FIG. 2 is an illustration of a ceramic metal halide lamp. The discharge vessel 1 is connected at one end to leadwire 31 which is attached to frame 35 and at the other end to leadwire 36 which is attached to mounting post 43. Electric power is supplied to the lamp through screw base 40. The threaded portion 61 of screw base 40 is electrically connected to frame 35 through leadwire 51 which is connected to a second mounting post 44. Base contact 65 of screw base 40 is electrically isolated from the threaded portion 61 by insulator 60. Leadwire 32 provides an electrical connection between the base contact 65 and the mounting post 43. Leadwires 51 and 32 pass through and are sealed within glass stem 47. A starting aid in the form of wire 39 is coiled around the lower capillary of the discharge vessel 1 and connected to frame 35. This produces a small capacitive discharge in the capillary to be used as an electron source in lieu of a UV-emitting starting aid.

A glass outer envelope 30 surrounds the discharge vessel and its associated components and is sealed to stem 47 to provide a gas-tight environment. Typically, the outer envelope is evacuated, although in some cases it may contain up to 400 torr of nitrogen gas. A getter strip 55 is used to reduce contamination of the envelope environment.

### EXAMPLES

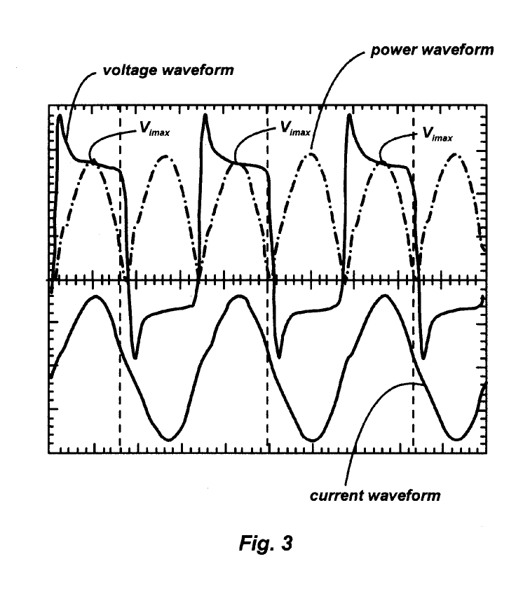

Referring to FIG. 3, there are shown the voltage, power, and current waveforms for a ceramic metal halide lamp. In this case, the discharge vessel was comprised of dysprosium oxide according to this invention. The voltage waveform is characterized by an ignition peak at the start of each ½ cycle followed by a relatively flat region during which the power and current waveforms reach their maximums. The positive voltage at which the current is at its maximum is defined herein as Vᵢₘₐₓ and may be used to monitor the warm-up characteristics of the lamp.

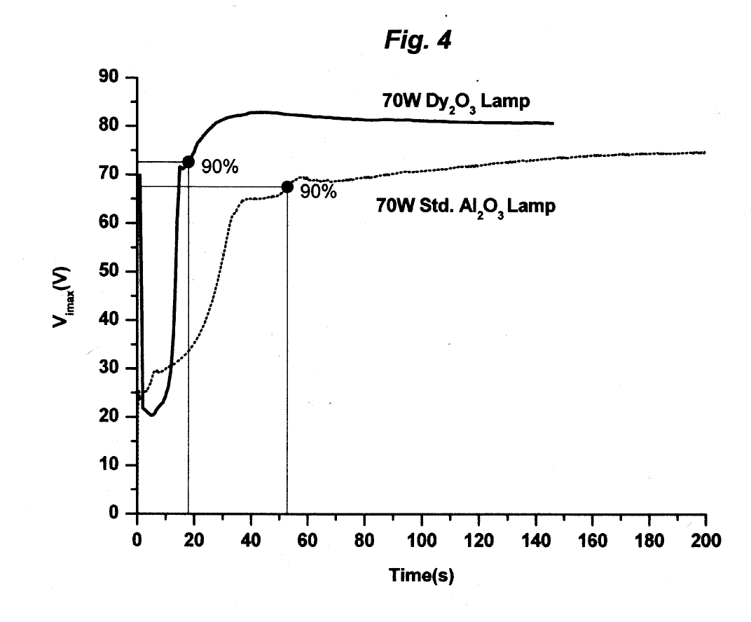

FIG. 4 is a plot of Vᵢₘₐₓ as a function of time measured from the initial ignition of the arc discharge. The graph shows the voltage rise characteristics of two lamps: a 70 W metal halide lamp with a polycrystalline dysprosium oxide discharge vessel and a standard 70 W metal halide lamp with a polycrystalline aluminum oxide discharge vessel. Except for the discharge vessel material, the lamps were similarly constructed and operated. In particular, the lamps were operated on a linear reactor at 60 Hz. The impedance was adjusted to deliver 70 W to each lamp during steady-state operation. Each lamp used the same ignitor and mounting structure. In each case, the dimensions of the tungsten electrodes were kept the same, the electrode gap was held to 7.4 mm and the lamp fill was 5.7 mg Hg and 7.6 mg of a metal halide salt mixture comprising 54.5% NaI, 6.6% DyI₃, 6.7% HoI₃, 6.3% TmI₃, 11.4% TlI: and 14.5% CaI₂ by weight. The lamps also contained 300 mbar Ar.

The Dy₂O₃ discharge vessels were slightly smaller than the standard 70 W PCA discharge vessel, however, the dimensional differences are not thought to be related to the observed rapid warm-up of the Dy₂O₃ vessels. This is because a relatively slow warm-up is present in all sizes and wattages of metal halide lamps with PCA discharge vessels. The dimensions of the vessels are given in Table 1.

TABLE 1

| | Dy₂O₃ vessel | PCA vessel |
|---|---|---|
| Capillary ID, mm | 0.70 | 0.80 |
| Capillary OD, mm | 1.96 | 2.65 |
| Body OD, mm | 8.0 | 9.7 |
| Wall thickness, mm | 0.52 | 0.80-0.90 |
| Overall length, mm | 36 | 38 |

The lamps are “warmed-up” to their steady-state operating condition when there is no longer a substantial change in Vᵢₘₐₓ. With reference to the curves in FIG. 4, the time rate of change of Vᵢₘₐₓ in both cases is seen to diminish asymptotically toward a value which is defined herein as the steady-state operating voltage, Vₛₛ. More particularly, the steady-state operating voltages of these two lamps may be obtained by fitting the terminal portion of the curves where t>100 secs with a first-order exponential curve, y=y0+A1 exp(−t/t1), wherein y0 represents asymptotic value of y at large values of t, A1 is the amplitude and t1 is the decay constant. For the lamp with the Dy₂O₃ discharge vessel, the values of Y0, A1 and t1 are 80.6, 92.5 and 19.5, respectively. For the standard lamp with the Al₂O₃ discharge vessel, the values of Y0, A1 and t1 are 75.1, −44.0, and 44.5, respectively. Since Y0 also represents the value of Vₛₛ, the values of Vₛₛ are 80.6 V for lamp with the Dy₂O₃ discharge vessel and 75.1 V for the standard lamp with the Al₂O₃ discharge vessel.

With the values of Vₛₛ determined it is possible to directly compare the warm-up performance of these lamps. As defined herein, the warm-up time of the lamp is the time following the initial arc ignition at which Vᵢₘₐₓ reaches 90% of the steady-state operating voltage, Vss. This threshold point is plotted in FIG. 4 for both lamps. For the lamp with the Dy₂O₃ discharge vessel, this point occurs at about 18 seconds after initial arc ignition. On the other hand, this point occurs at a much latter time, about 53 seconds, for the standard lamp with the Al₂O₃ discharge vessel. Thus, the warm-up time of the lamp with the Dy₂O₃ discharge vessel is only about ⅓ the warm-up time of the standard lamp.

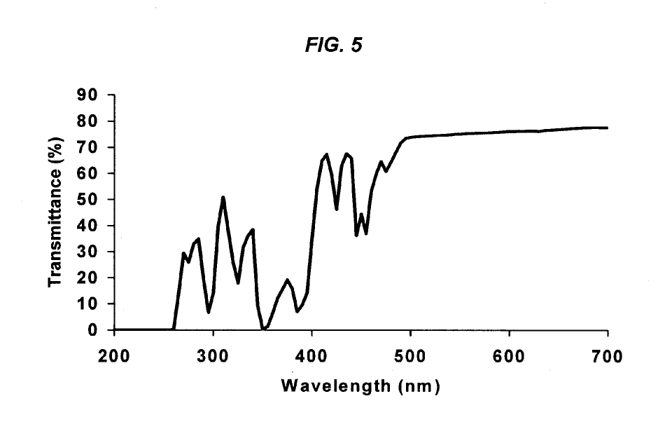

This effect is not to be expected if one considers that Dy₂O₃ when compared to PCA has a lower thermal diffusivity (about 5 times lower at 500° C.) and a lower thermal conductivity (about 7 times lower). If heat conduction in the ceramic were the sole mechanism of heat transport, then it would be expected that there would be a slower heating of the cold end of the Dy₂O₃ vessel leading to a slower warm-up. Therefore, as stated earlier, radiation absorption must have played an important role in the observed rapid warm-up in the Dy₂O₃ vessel. The absorption properties of Dy₂O₃ can been seen in FIG. 5 which shows the in-line transmittance of a polished polycrystalline dysprosium disk. The strong UV and blue absorption of the polycrystalline dysprosium oxide is indicated by the low transmittance values from 200 to about 475 nm.

A further consideration is the lower heat capacity of Dy₂O₃. In terms of voluminous heat capacity, PCA is actually 1.5 times higher than Dy₂O₃. Thus, on the basis of heat capacity alone, it would take less heat to raise the temperature of a Dy₂O₃ vessel at a given volume. This is also believed to be an important contributor to the rapid warm-up of the Dy₂O₃ vessel.

While there have been shown and described what are present considered to be the preferred embodiments of the invention, it will be apparent to those skilled in the art that various changes and modifications can be made herein without departing from the scope of the invention as defined by the appended claims.

What is claimed is:

1. A ceramic metal halide lamp comprising: a ceramic discharge vessel comprised of dysprosium oxide, the lamp having a warm-up time that is less than about 50% of the warm-up time of a similarly constructed and operated lamp having a ceramic discharge vessel made of polycrystalline aluminum oxide.

2. The lamp of claim 1 wherein the lamp has a warm-up time that is less than about one-third of the warm-up time of a similarly constructed and operated lamp having a ceramic discharge vessel made of polycrystalline aluminum oxide.

3. The lamp of claim 1 wherein the discharge vessel is bulgy-shaped.

4. The lamp of claim 1 wherein lamps are not operated in an over-wattage condition.

5. A ceramic metal halide lamp comprising:
a base adapted for connecting to a source of electrical power;
an outer envelope attached to the base;
a discharge vessel mounted within the outer jacket, the discharge vessel having a hollow ceramic body that encloses a discharge chamber and is comprised of dysprosium oxide, capillary tubes extending outwardly from and attached to the body, each capillary tube having an electrode assembly therethrough;
each electrode assembly having a discharge tip protruding into the discharge chamber and an opposite end extending from a distal end of its respective capillary, the opposite ends being electrically connected to the base; each electrode assembly being sealed to its respective capillary with a frit material;
the discharge chamber containing a metal halide fill material and a buffer gas; and
the ceramic metal halide lamp having a warm-up time that is less than about 50% of the warm-up time of a similarly constructed and operated lamp having a ceramic body comprised of polycrystalline aluminum oxide.

6. The lamp of claim 5 wherein the lamp has a warm-up time that is less than about one-third of the warm-up time of a similarly constructed and operated lamp having a ceramic discharge vessel made of polycrystalline aluminum oxide.

7. The lamp of claim 5 wherein the discharge vessel is bulgy-shaped.

8. The lamp of claim 5 wherein lamps are not operated in an over-wattage condition.

9. A ceramic metal halide lamp comprising:
a base adapted for connecting to a source of electrical power;
an outer envelope attached to the base;
a discharge vessel mounted within the outer jacket, the discharge vessel having a hollow ceramic body that encloses a discharge chamber and is comprised of dysprosium oxide, capillary tubes extending outwardly from and attached to the body, each capillary tube having an electrode assembly therethrough;
each electrode assembly having a discharge tip protruding into the discharge chamber and an opposite end extending from a distal end of its respective capillary, the opposite ends being electrically connected to the base; each electrode assembly being sealed to its respective capillary with a frit material;
the discharge chamber containing a metal halide fill material and a buffer gas; and
wherein the lamp is designed to be operated at 70 watts and has a warm-up time of less than about 20 seconds.
